(19) United States
(12) Patent Application Publication
(10) Pub. No.: US 2007/0078980 A1
(43) Pub. Date: Apr. 5, 2007

(54) Control system

(75) Inventors: Toshihiro Tomita, Tokyo (JP); Tetsuo Hoshi, Tokyo (JP)

Correspondence Address: EDWARDS & ANGELL, LLP, P.O. BOX 55874, BOSTON, MA, 02205, US

(73) Assignee: Yokogawa Electric Corporation, Tokyo (JP)

(21) Appl. No.: 10/580,156

(22) PCT Filed: Oct. 15, 2004
(86) PCT No.: PCT/JP04/15239

§ 371 Date: May 19, 2006

(30) Foreign Application Priority Data
Nov. 19, 2003 (JP) 2003-389345

(51) Int. Cl. G06F 15/173

(52) U.S. Cl. 709/225; 709/245

(57) ABSTRACT

It is an object to provide a control system wherein a system configuration can be changed in a short time. To do this, the invention adds improvement to a control system established through a network. The control system includes: a plurality of system component nodes each having a communication section for generating a unique global address by the system component node itself upon connection to the network, and for transmitting the generated global address, attribute information of the system component node and installation position information of the system component node, to the network; and a management node for monitoring and operating the system component nodes through the network and managing control of the whole control system, wherein the management node includes: a communication section for performing communication through the network; a storage section for storing definition information of the system component nodes; a display section for displaying an operation and monitor screen; a definition information generation section for generating definition information based on the global address, the attribute information and the position information which are acquired through the network, and for storing the definition information in the storage section; a screen generation section for making the display section display the operation and monitor screen of the system component nodes from the definition information in the storage section; and a control function providing section for reading information defining an operation of the system component node from the storage section, and for outputting the read information to the communication section.

### TECHNICAL FIELD

This invention relates to a control system established through a network, and more particularly, to a control system wherein a system configuration can be changed in a short time.

### BACKGROUND ART

Control systems are available on various scales from a large-scale control system as called IA (Industrial Automation) (for example, control and monitor of a plant), to a medium-scale control system as called BA (Building Automation) (for example, control and monitor of air conditioning, lighting, etc., of a building), to a small-scale control system as called LA (Laboratory Automation) (for example, control and monitor of a small number of (several to several ten) machines installed in a laboratory).

Such a control system displays various pieces of information required for controlling and running the system on a display screen of a display section of a management node for managing control of the whole control system and if an abnormality occurs in the system, displays the abnormality as an alarm for notifying the operator of the abnormality, who then can operate the management node for the abnormality to take steps of giving appropriate commands to system component nodes, acknowledging the alarm, etc.

FIG. 1 is a drawing to the configuration of a control system in a related art in a plant. In FIG. 1, a management node 10 is connected to a network 100 and defines, monitors, and operates the plant and manages control of the whole plant. The management node 10 includes a display section of a CRT screen, a liquid crystal screen, etc. The network 100 may be wire or wireless.

Controllers 20 to 22 are distributed in the plant and communicate with the management node 10 through the network 100 (in FIG. 1, three controllers are connected by way of example, but any number of controllers may be connected). A sensor 30 measures an object, such as a temperature sensor, a pressure sensor, a flowmeter, or a switch. An actuator 31 is a valve, a motor, a pump, etc., for example. Here, the controllers, the sensors, and the actuators are called system component nodes.

As many sensors 30 and actuators 31 as required for controlling the plant are connected to each of the controllers 20 to 22. (FIG. 1 shows that two sensors 30 and one actuator 31 are connected to each of the controllers 20 to 22 by way of example, but as many sensors and actuators as required for each of the controllers 20 to 22 may be connected, of course). Each of the controllers 20 to 22 inputs a signal from the sensor 30 and controls the actuator 31.

Subsequently, the management node 10 will be discussed in detail.

The management node 10 has a system configuration definition database (hereinafter, database will be abbreviated as DB) 11, a network definition DB 12, a tag definition DB 13, a control function definition DB 14, and an operation and monitor screen definition DB 15. Here, the definition information stored in the DB 11 to the DB 15 is collectively called system definition information group. The DB 11 to the DB 15 are storage sections.

The operation of such an apparatus is as follows:

First, before the plant is controlled, system design for controlling the plant is conducted.

The numbers and the installation locations of the controllers 20 to 22, the sensors 30, and the actuators 31 and the like are designed. Position information for installing the controllers 20 to 22 is defined in the system configuration definition DB 11 and the network addresses assigned to the controllers 20 to 22 are defined in the network definition DB 12. Further, the names (tags) and the connection positions of the sensors 30 and the actuators 31 connected to the controllers 20 to 22 are defined in the tag definition DB 13.

The control functions to be executed by the system component nodes are defined in the control function definition DB 14. For example, for the controllers 20 to 22, a monitor program of the upper and lower limit values for the signals from the sensors 30 and the actuators 31, parameters and a control program of PID control for controlling the actuators 31 based on the signals input from the sensors 30, and the like are defined. For the sensors 30 and the actuators 31, the input/output method and the format of input/output signals and the like are defined.

Further, information for displaying the system configuration on the display section of the management node and performing processing for operation of the operator is defined in the operation and monitor screen definition DB 15.

The whole system is thus predefined in the DBs 11 to 15 and the system design is complete.

The system component nodes are installed in order in the plant based on the definition information of the system definition information group. For example, the network addresses are set in the controllers 20 to 22 and the controllers 20 to 22 are installed at predetermined positions and are connected to the network 100. The sensors 30 and the actuators 31 are installed at predetermined positions and are connected to the controllers 20 to 22.

Upon completion of the installation, the management node 10 downloads the control functions in the control function definition DB 14 into the system component nodes. Upon completion of downloading the control functions into all system component nodes, it is made possible to operate and monitor the control system using the screen from the management node 10, and plant control can be managed.

This means that the distributed controllers 20 to 22 perform predetermined control operations, etc., using the signals from the various sensors 30 and operate the actuators 31 for controlling the plant. The controllers 20 to 22 monitor the upper and lower limit values for input data, output data, etc., and if the upper and lower limit value range is exceeded, the controllers 20 to 22 transmit an alarm signal, etc., indicating the event through the network 100 to the management node 10. Further, the various control functions handled by the controllers 20 to 22 are sent through the network 100 to the management node 10, which then displays the control functions, the monitor result, etc., of the plant on the display section. The operator monitors the display section and again sets the control functions for running and operating the plant in the management node 10 as required and causes the management node 10 to transmit the again set control functions through the network 100 to the controllers 20 to 22.

In such a system, the system component nodes may be changed (added, deleted, replaced). The numbers, the types, the uses, the control functions, etc., of the system component nodes are all designed in detail before the system is operated. Thus, whenever any system component node is changed, the system design is again conducted from the beginning and the definitions in the DBs 11 to 15 involved in the change are also changed and then the system component node is actually changed.

Patent document 1: JP-A-11-231927 (paragraph numbers 0002-0009, FIG. 1)

In recent years, the system component nodes in the plant have been frequently changed for improving the quality of the products manufactured in the plant, shortening the delivery time of the products, reducing the manufacturing costs of the products, etc.

However, if one system component node is changed, for example, at a job site in the plant, it is necessary each time to correct the relevant DBs 11 to 15 of the system definition information group and generate screens of the display section, set the addresses of the system component nodes, and download the control functions in accordance with the corrected definition information, and thus an enormous number of steps are required; this is a problem.

It is therefore an object of the invention to provide a control system wherein a system component node can be changed (added, replaced, deleted) in a short time.

### MEANS FOR SOLVING THE PROBLEMS

In order to solve such a problem, the invention is configured as follows:

(1) A control system established through a network, the control system comprising:

a plurality of system component nodes each having a communication section for generating a unique global address by the system component node itself upon connection to the network, and for transmitting the generated global address, attribute information of the system component node and installation position information of the system component node, to the network; and

a management node for monitoring and operating the system component nodes through the network and managing control of the whole control system, wherein

the management node includes:

a communication section for performing communication through the network;

a storage section for storing definition information of the system component nodes;

a display section for displaying an operation and monitor screen;

a definition information generation section for generating definition information based on the global address, the attribute information and the position information which are acquired through the network, and for storing the definition information in the storage section;

a screen generation section for making the display section display the operation and monitor screen of the system component nodes from the definition information in the storage section; and

a control function providing section for reading information defining an operation of the system component node from the storage section, and for outputting the read information to the communication section.

(2) The control system as described in (1), wherein the system component nodes are at least one of a sensor, an actuator and a controller.

(3) The control system as described in (1), wherein the definition information includes the global address, an installation position, a tag, a control function and a configuration of the operation and monitor screen of the system component node.

(4) The control system as described in (1), wherein the definition information generation section has an attribute information determination section for determining validity of the attribute information.

(5) The control system as described in (1) or (4), wherein the attribute information includes at least one of a type, a manufacturer, a model and a serial number of the system component node.

(6) The control system as described in (1), wherein the communication sections of the system component node and the management node have an address generation section for generating a unique global address.

(7) The control system as described in (1), wherein the communication sections of the system component node and the management node perform packet communication.

(8) The control system as described in (7), wherein the communication section has an authentication section for adding authentication data to a header of a packet, and determining validity of the received packet according to the authentication data added to the packet.

(9) The control system as described in (7), wherein the communication section has a cryptograph processing section for encrypting a packet.

(10) The control system as described in (7), wherein the communication section of the system component node multicasts a packet including the generated global address as a source address to all of the management node and the system component nodes connected to the system, and

the communication section of the management node receives the multicasted packet and sends a response to the received packet to the system component node.

(11) The control system as described in any of (6) to (10), wherein Internet protocol specification IPv6 is used as a communication protocol for connecting to the network.

(12) The control system as described in (1), wherein the system component node has a position detection section for detecting the installation position.

(13) The control system as described in (12), wherein the position detection section detects the position using radio waves or ultrasonic waves.

(14) The control system as described in (1), wherein the network has a switching hub, and

the system component node is connected to the switching hub.

(15) The control system as described in (2), wherein the controller has a self-learning section for learning more appropriate control function by performing transmission and reception to and from the sensor and the actuator, and transmits the learned control function to the management node, and the definition information generation section of the management node generates the definition information according to the control function from the controller.

(16) The control system as described in (1), wherein the management node performs communication with the system component node through the network.

The invention provides the following advantages.

The communication section of the system component node generates the unique global address, establishes communication with the management node, and transmits the position information and the attribute information to the management node. The management node changes the definition information in the storage section from the position information and the attribute information, and the screen generation section displays the most recent operation and monitor screen on the display section. Accordingly, the operation can be started immediately after a system component node is connected without the need for the system designer or developer to change the storage section in an enormous number of steps each time a system component node is changed. Therefore, the system configuration can be changed in a short time and the efficiency of system construction, administration, and maintenance can be improved drastically.

If addition, deletion, or replacement of system component node results in a mismatch between the actual installation situation and the descriptions of the storage section, the definition information generation section detects and corrects the descriptions of the storage section by itself, so that system mismatch can be suppressed.

Since the communication section generates the unique global address, the address does not become duplicate in the management node and the system component nodes. Therefore, it is unnecessary for the designer or the developer to check the addresses stored in the storage section and assigns the addresses.

Since the attribute information determination section determines the attribute information from the system component node for validity, if a third party connects an unauthorized system component node, the data from the unauthorized system component node can be removed. Therefore, the system reliability improves and an installation mistake can also be prevented.

Each of the communication sections of the system component nodes and the management node conduct packet communications and thus can multiplex and transmit. Accordingly, if the number of lines of the network is small, efficient communications can be conducted. Communications can also be conducted between the nodes and different in communication speed and communication means.

The authentication section of the communication section adds the authentication data to the header of each packet. Since the received packet is determined for validity based on the authentication data, the validity of the packet can be easily determined at the packet level and the system reliability improves.

Since the cryptograph processing section of the communication section encrypts a packet for transmission, leak, tampering, etc., of the data in the packet can be prevented and security improves.

The communication section of each system component node multicasts the packet including the generated global address as the source address to all of the management node and the system component nodes connected to the system, and the communication section of the management node receives the multicasted packet and sends a response to the received packet to the system component node, so that the system component node can automatically recognize the management node.

The communication section uses the Internet protocol specification IPv6 as the communication protocol for connecting to the network and thus can encrypt a packet, add authentication data to the header of the packet, and generate the global address according to the specifications.

Since the position detection section detects the position where the home node is installed, if the operator misunderstands the installation position, the correct installation position is displayed on the display screen of the display section and thus an installation mistake can be prevented.

Since the switching hubs are provided between the network and the system component nodes, only the packets other than those transmitted to the system component nodes in the same switching hub are transmitted to the network. Accordingly, the traffic of the network can be lessened.

The self-learning section of the controller learns more appropriate control functions by transmitting and receiving the input/output signals to/from the sensor and the actuator and reflects the control functions on the storage section of the management node, so that the need for the operator to find the optimum control function from the operation and monitor screen of the display section and store the optimum control function in the storage section is eliminated. Accordingly, the number of steps taken after the system configuration is changed can be reduced.

Since communications are conducted using the Internet, the management node and the system component nodes distributed in a wide area need not be connected by a leased line or a public network charged in response to the communications traffic for conducting communications and the laying cost and the communication charge can be suppressed.

### BRIEF DESCRIPTION OF THE DRAWINGS

FIG. 1 is a diagram of a configuration of a control system in IA in a related art.

FIG. 2 is a diagram of a configuration to show a first embodiment of the invention.

FIG. 3 is a block diagram to show a configuration example of a system component node 40 of the system shown in FIG. 2.

FIG. 4 is a diagram to show a configuration example of a management node 50 of the system shown in FIG. 2.

FIG. 5 is a chart to show an operation example of the system shown in FIG. 2.

FIG. 6 is a diagram of s configuration to show a second embodiment of the invention.

FIG. 7 is a diagram of s configuration to show a third embodiment of the invention.

### BEST MODE FOR CARRYING OUT THE INVENTION

Embodiments of the invention will be discussed below with the accompanying drawings.

[First Embodiment]

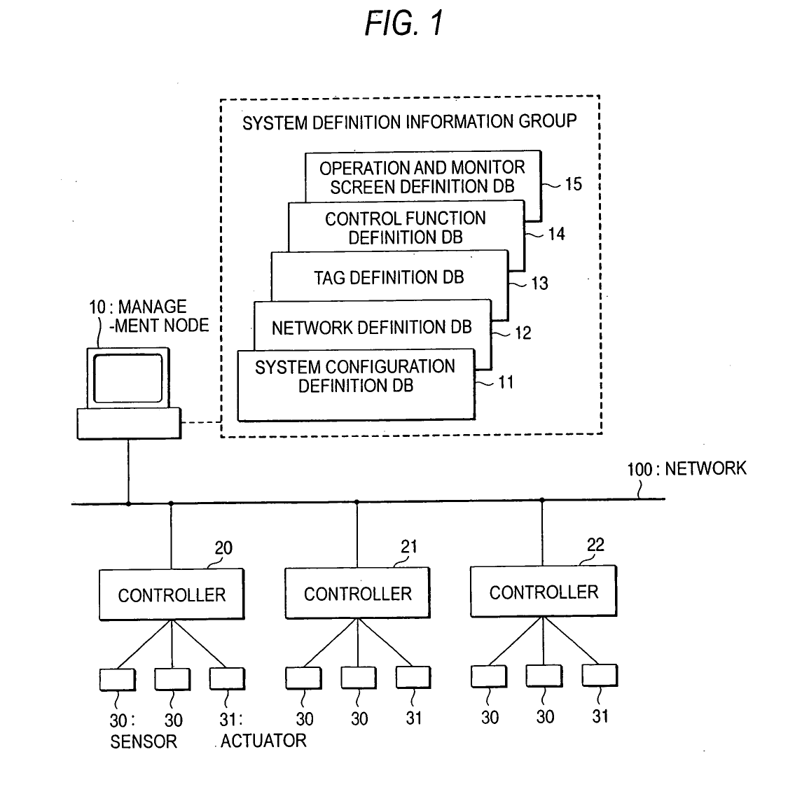

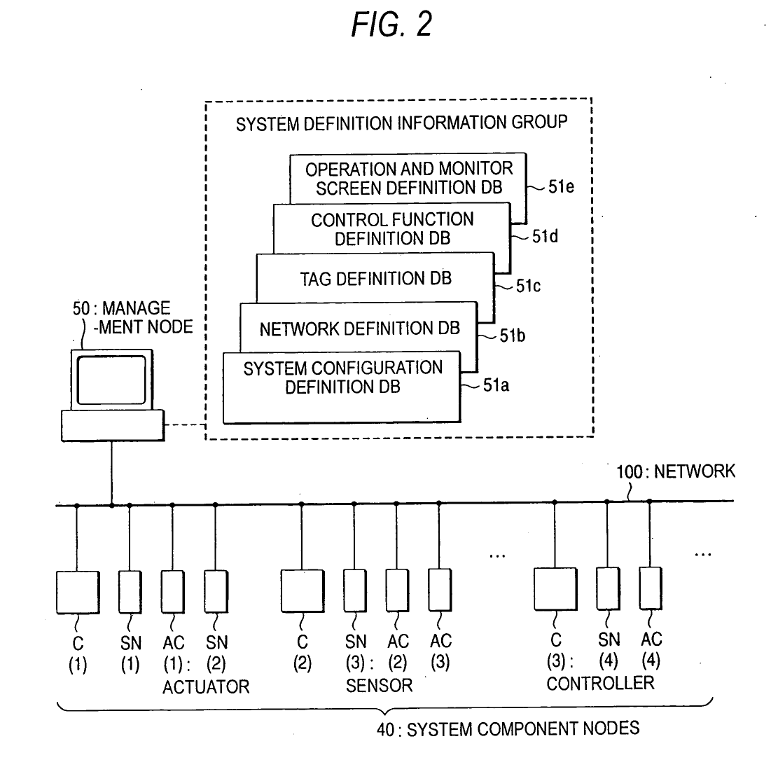

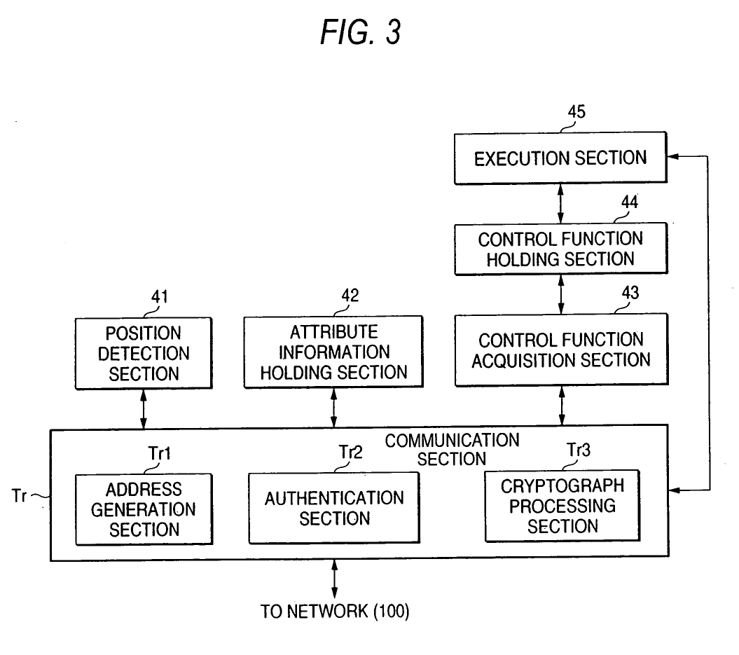

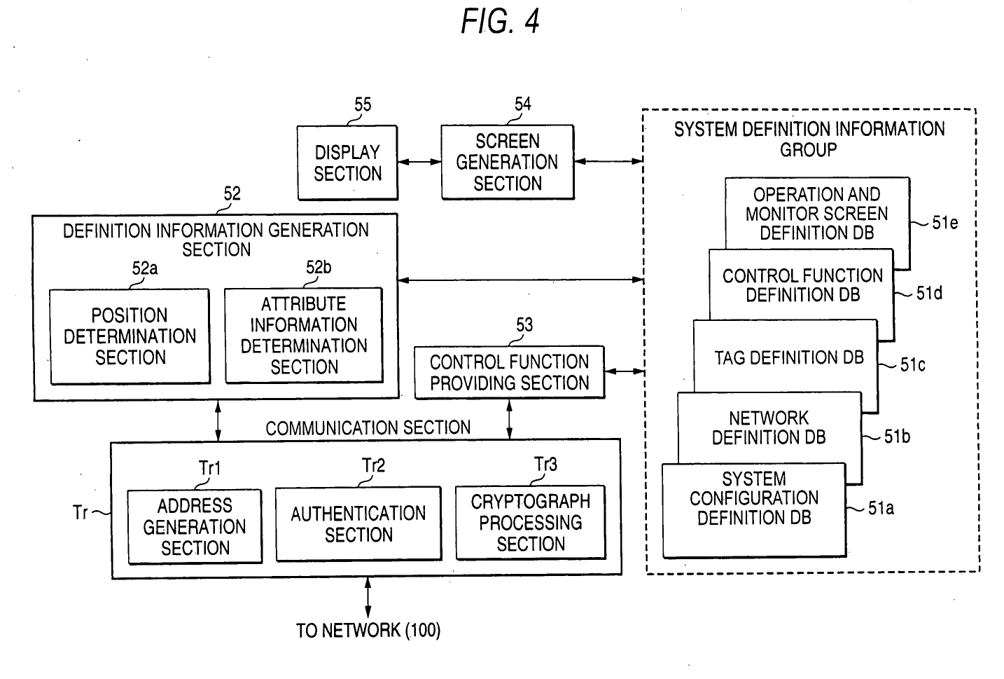

FIG. 2 is a diagram of a configuration to show a first embodiment of the invention. FIG. 3 is a block diagram to show a configuration of a system component node 40. FIG. 4 is a diagram to show a configuration of a management node 50. Parts identical with those in FIG. 1 are denoted by the same reference numerals in FIGS. 2 to 4 and will not be discussed again. In FIGS. 2 to 4, controllers C(1) to C(3), sensors SN(1) to SN(4), and actuators AC(l) to AC(4) are connected to a network 100 in stead of the controllers 20 to 22, the sensors 30, and the actuators 31 (in FIG. 2, three controllers, four sensors, and four actuators are connected by way of example, but any numbers of controllers, sensors, and actuators may be connected) Here, the controllers C(1) to C(3), the sensors SN(1) to SN(4), and the actuators AC(1) to AC(4) are called system component nodes 40. Unlike the apparatus shown in FIG. 1, the system component nodes 40 are not connected in a plurality of layers and are connected in the same layer to the network 100.

Each of the controllers C(l) to C(3), the sensors SN(l) to SN(4), and the actuators AC(1) to AC(4) has a communication section Tr, a position detection section 41, an attribute information holding section 42, a control function acquisition section 43, a control function holding section 44, and an execution section 45.

The communication section Tr has an address generation section Tr1, an authentication section Tr2, and a cryptograph processing section Tr3 and is connected to the network 100. The communication section Tr uses Internet protocol specification IPv6 (Internet Protocol version 6) as communication protocol for connecting to the network 100 to conduct packet communications.

When the system component node is connected to the network 100, the address generation section Tr1 generates a unique global address in accordance with the IPv6 specifications. The authentication section Tr2 adds authentication data to a header of a packet in accordance with the IPv6 specifications. It also determines the received packet for validity based on the authentication data added to the packet. The cryptograph processing section Tr3 encrypts a plaintext packet to be transmitted and restores the received encrypted packet to the former plaintext.

The position detection section 41 is, for example, a GPS (Global Positioning System) for performing position determination using radio waves from an artificial satellite and detects the position where the home node is installed in a plant and outputs installation position information to the communication section Tr. The attribute information holding section 42 retains attribute information proper to the node (including at least one of the type of home node (controller, sensor type, actuator type, etc.,), the manufacturer, the model, and the serial number) and outputs the attribute information to the communication section Tr.

The control function acquisition section 43 acquires control functions from the communication section Tr and stores the control functions in the control function holding section 44. The execution section 45 reads and executes the control functions stored in the control function holding section 44 based on the data acquired by the communication section Tr and outputs the execution result to the communication section Tr.

The management node 50 is provided in place of the management node 10. The management node 50 has definition information storage DBs 51a to 51e (which are storage sections), a communication section Tr, a definition information generation section 52, a control function providing section 53, a screen generation section 54, and a display section 55; it is connected to the network 100, defines, monitors, and operates the plant, and manages control of the whole plant.

The system configuration definition DB 51a stores the attributes including the positions where the controllers C(1) to C(3) are installed as definition information. The network definition DB 51b stores the global addresses of the controllers C(1) to C(3), the sensors SN(1) to SN(4), and the actuators AC(l) to AC(4). The tag definition DB 51c stores the attributes including the tags of the controllers C(1) to C(3), the sensors SN(1) to SN(4), and the actuators AC(1) to AC(4) and the installation positions of the sensors SN(1) to SN(4) and the actuators AC(1) to AC(4).

The control function definition DB 51d stores the control functions defining the operation of the controllers C(1) to C(3), the sensors SN(1) to SN(4), and the actuators AC(1) to AC(4). For example, for the controllers C(1) to C(3), a monitor program of the upper and lower limit values for the signals from the sensors SN(1) to SN(4) and the actuators AC(1) to AC(4), parameters and a control program of PID control for controlling the actuators AC(1) to AC(4) based on the signals from the sensors SN(1) to SN(4), the sensors SN(1) to SN(4) and the actuators AC(1) to AC(4) for performing control and monitor, and the like are defined. For the sensors SN(1) to SN(4) and the actuators AC(1) to AC(4), the input/output method and the format of input/output signals and the like are defined.

The operation and monitor screen definition DB 51e stores configuration information of an operation and monitor screen to display the system configuration, graphics for the operator to operate, and the like on the display section 55. Here, the definition information stored in the DB 51a to the DB 51e is collectively called system definition information group.

The definition information generation section 52 has a position determination section 52a and an attribute information determination section 52b; it generates definition information of the system definition information group in accordance with the data from the communication section Tr and stores the definition information in the DBs 51a to 51e. The position determination section 52a determines the position where the system component node 40 is installed in the plant. The attribute information determination section 52a determines the attribute information of the system component node 40 for validity.

The control function providing section 53 reads the control functions from the control function definition DB 51d and outputs the control functions to the communication section Tr. The screen generation section 54 reads the definition information of the operation and monitor screen from the operation and monitor screen definition DB 51e and causes the display section 55 to display the operation and monitor screen.

The operation of such an apparatus is as follows:

First, before the plant is controlled, system design for controlling the plant is conducted.

As with the apparatus shown in FIG. 1, the plant designer, developer, etc., designs the numbers, the specifications, the installation locations, etc., of the controllers C(1) to C(3), the sensors SN(1) to SN(4), and the actuators AC(1) to AC(4) Position information for installing the controllers C(1) to C(3), etc., is defined in the system configuration definition DB 51a. The network addresses of the controllers C(1) to C(3), the sensors SN(1) to SN(4), and the actuators AC(1) to AC(4) need not be defined in the network definition DB 51b.

The tags of the controllers C(1) to C(3), the sensors SN(1) to SN(4), and the actuators AC(1) to AC(4) and the installation positions of the sensors SN(1) to SN(4) and the actuators AC(1) to AC(4), etc., are defined in the tag definition DB 51c. Association information among the system component nodes 40 as to which of the controllers C(1) to C(3) controls the sensors SN(1) to SN(4), the actuators AC(1) to AC(4) is also defined in the tag definition DB 51c.

Further, the control functions to be executed by the system component nodes 40 are defined in the control function definition DB 51d. The format of the operation and monitor screen for displaying the system configuration on the display section 55 of the management node 50 and performing processing for operation of the operator is defined in the operation and monitor screen definition DB 51e.

The whole system is thus predefined in the DBs 51a to 51e and the system design is complete.

Subsequently, the operation of installation is as follows:

First, the management node 50 is connected to the network 100. Accordingly, the address generation section Tr1 of the communication section Tr of the management node 50 generates a unique global address in accordance with the IPv6 specifications.

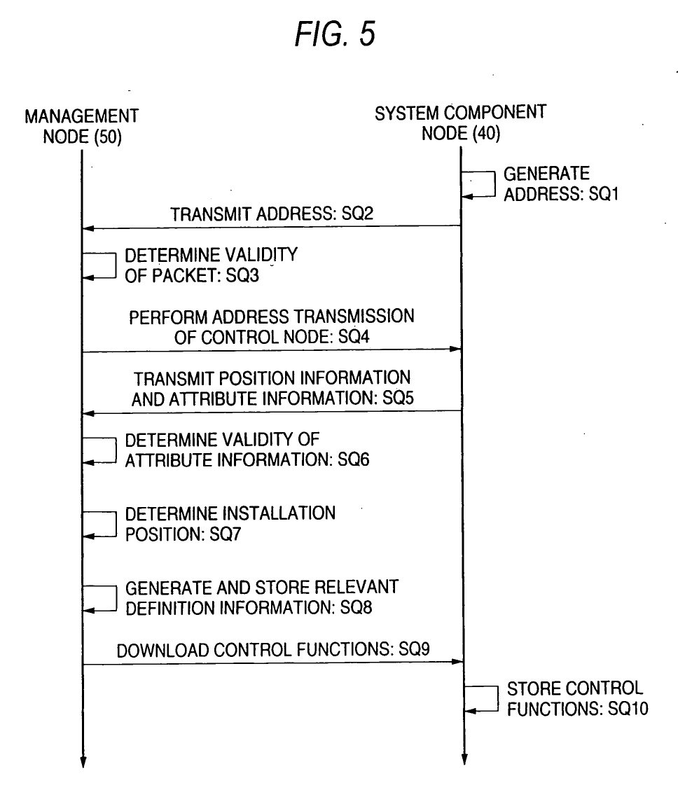

After the management node 50 is connected to the network 100 and is installed, the system component nodes 40 are installed in order in the plant based on the definition information of the system definition information group. FIG. 5 is a chart to describe the operation of the installation of the system component node 40.

When one of the system component nodes 40 is connected to the network 100, the address generation section Tr1 of the communication section Tr of the system component node 40 generates the unique global address (SQ1). The communication section Tr generates a packet with the address generated by the address generation section Tr1 as the source address. Further, the authentication section Tr2 adds predetermined authentication data to the header of the packet. The cryptograph processing section Tr3 encrypts the packet to which the authentication data is added. The communication section Tr link-local multicasts the encrypted packet with the inside of a local area network installed in the plant as the scope (SQ2).

On the other hand, the communication section Tr of the management node 50 receives the multicasted packet. The cryptograph processing section Tr3 converts cryptograph of the packet into plaintext. Further, the authentication section Tr2 determines validity at the packet level. That is, if the authentication data included in the header of the packet is authenticated according to a predetermined authentication algorithm, the authentication section Tr2 determines that the valid system component node 40 is connected. The communication section Tr of the management node 50 generates a packet with the address generated by the address generation section Tr1 as the source address, and the authentication section Tr2 adds predetermined authentication data to the header of the packet. Further, the cryptograph processing section Tr3 encrypts the packet to which the authentication data is added. The communication section Tr transmits the encrypted packet to the address included in the received packet (SQ4).

The communication section Tr of the system component node 40 receives the packet transmitted to the home node. The cryptograph processing section Tr3 converts the received packet into plaintext, and the authentication section Tr2 determines the authentication data for validity. If the authentication data is authenticated, the communication section Tr reads and retains the address of the management node 50 included in the packet. Further, the position detection section 41 outputs installation position information of the home node 40 to the communication section Tr, and the attribute information holding section 42 outputs the attribute information to the communication section Tr. The communication section Tr generates a packet including the position information and the attribute information as data, adds authentication data to the header, encrypts the data, and transmits the packet to the management node 50 with the retained address of the management node 50 as the destination (SQ5).

On the other hand, the communication section Tr of the management node 50 extracts the position information and the attribute information from the received packet (after conversion to plaintext and being authenticated, of course), and outputs the position information and the attribute information to the definition information generation section 52. The attribute information determination section 52b checks to see if predefined attribute information in DB not shown and the attribute information of the received packet match. The check items may be all of the type of system component node 40, the manufacturer, the model, and the serial number or may be only any desired item. If the former attribute information and the latter attribute information do not match, the packet is determined invalid and communications with the system component node 40 transmitting the packet are disconnected. If the attribute information is valid, communications are not disconnected (SQ6). The position determination section 52a of the definition information generation section 52 determines what position in the plant the system component node 40 is installed at (SQ7).

Further, the definition information generation section 52 reads the information defined in the system configuration definition DB 51a and the tag definition DB 51c. Whether or not the system component node 40 is installed at the correct position in the plant is checked from the position determined by the position determination section 52a and the read definition information. If the system component node 40 is installed at an incorrect position, the position where the system component node 40 is installed is stored in the operation and monitor screen definition DB 51e. The screen generation section 54 may read the descriptions stored in the operation and monitor screen definition DB 51e and display a warning indicating that the system component node 40 is installed at an incorrect position, the current installation position, and the correct position on the display section 55. After it is checked that the system component node 40 is installed at the correct position, the global address of the system component node 40 is added to the network definition DB 51b (SQ8).

Further, the control function providing section 53 reads the tag from the tag definition DB 41c and reads the control functions from the control function definition DB 51d and outputs them to the communication section Tr. Further, the communication section Tr creates a packet including the tag and the control functions as data, adds authentication data to the header, and encrypts the data. Then, it transmits the packet to the system component node 40 and downloads (SQ9).

The system component node 40 of the destination converts the packet received from the management node 50 into plaintext, determines the authentication data for validity, and outputs the control functions included in the packet to the control function acquisition section 43. The control function acquisition section 43 converts into data in an executable format and stores the data in the control function holding section 44 (SQ10). The initial installation at the system constructing time is now complete.

The system component node whose installation is complete multicasts a packet including an identifier indicating the normal operation as data to the management node 50 and the relevant system component nodes 40 at regular time intervals. Alternatively, the management node 50 receives a packet including an identifier indicating the normal operation from a specific system component node 40 by polling.

When the data has been downloaded into all system component nodes 40, it is made possible to operate and monitor the control system through the screen from the management node 50, and plant control can be managed.

That is, the execution section 45 of each of the sensors SN(1) to SN(4) reads the control functions from the control function holding section 44 and executes measurement and controls the home node SN(1) to SN(4) according to a command from each of the controllers C(1) to C(3), and outputs the results to the communication section Tr. The communication section Tr of the sensor SN(1) to SN(4) generates a packet including the results as data, adds authentication data to the header, encrypts the packet, and transmits the packet to the controller C(1) to C(3) issuing the command.

Likewise, the execution section 45 of each of the actuators AC(1) to AC(4) reads the control functions from the control function holding section 44 and controls (opens/closes the valve, turns on/off the motor, etc.,) according to a command from each of the controllers C(1) to C(3), and outputs the control result to the communication section Tr. The communication section Tr of the sensor AC generates a packet including the result as data, adds authentication data to the header, encrypts the packet, and transmits the packet to the controller C(1) to C(3) issuing the command.

The communication sections Tr of the distributed controllers C(1) to C(3) receive the packets from the communication sections Tr of the various sensors SN(1) to SN(4) Using the received packet data, predetermined control operations, etc., are performed and the actuators AC(1) to AC(4) are operated for controlling the plant. Each of the controllers C(1) to C(3) monitors the upper and lower limit values for input data, output data, etc., and if the upper and lower limit value range is exceeded, each of the controllers C(1) to C(3) converts an alarm signal, etc., indicating the event into a packet and transmits the packet through the network 100 to the management node 50. Further, the various control functions handled by the controllers C(1) to C(3) are sent through the network 100 to the management node 50, which then displays the control functions, the monitor result, etc., of the plant on the display section 55. The operator monitors the display section 55 and again sets the control functions for running and operating the plant in the management node 50 as required and causes the management node 50 to transmit the again set control functions through the network 100 to the controllers C(1) to C(3).

Subsequently, the operation for changing (adding, deleting, replacing) a system component node will be discussed.

(1) To add system component node 40.

First, the attribute information of the system component nodes to be added (for example, sensors SN(1) to SN(4)) is stored in a DB not shown possessed by the attribute information determination section 52b of the management node 50. The sensors SN(1) to SN(4) are connected to the network 100. Then, the management node 50 and the sensors SN(1) to SN(4) execute the steps of address generation (SQ1) to determination of the installation positions of the sensors SN(1) to SN(4) (SQ7) as in the operation shown in FIG. 5.

The definition information generation section 52 checks the network definition DB 51b to see if the network addresses of the sensors SN(1) to SN(4) exist and if the network addresses do not exist, it is determined that the sensors SN(1) to SN(4) are newly added. The network addresses are newly added to the network definition DB 51b and new tags are added to the tag definition DB 51c. For the tag, for example, a portion of a serial number may be previously created for adding a new number. The types, the installation positions, etc., of the sensors SN(1) to SN(4) are defined in the operation and monitor screen definition DB 51e. Accordingly, the screen generation section 54 reads the new definition information from the operation and monitor screen definition DB 51e and displays an operation and monitor screen to which the sensors SN(1) to SN(4) are added on the display section 55.

From the installation positions, the definition information concerning the system component nodes 40 relevant to the sensors SN(1) to SN(4) is also changed. For example, the plant is divided into areas at the system design time and the system component nodes 40 included in the areas where the sensors SN(1) to SN(4) are installed are applied. The control functions of the controllers C(1) to C(3) are defined so as to perform control operations based on the input signals of the sensors SN(1) to SN(4) for operating the actuators AC(1) to AC(4). However, if the sensors SN(1) to SN(4) are added, the number of input signals increases. The definition information generation section 52 may define a control function for averaging the output values of the nearby sensors SN(1) to SN(4) to provide an input signal and performing control operations. If a controller rather than the sensors SN(1) to SN(4) is added, the position of the controller may be added to the system configuration definition DB 51a. Thus, the definition information generation section 52 generates and stores the definition information in the relevant DBs 51a to 51e.

The control function providing section 53 downloads the tags and the control functions into the sensors SN(1) to SN(4) and the system component nodes 40 relevant to the sensors SN(1) to SN(4) (SQ9) and the control function acquisition section 43 converts the received packet into data in an executable format and stores the data in the control function holding section 44 (SQ10) as in the operation shown in FIG. 5.

(2) To delete system component node 40.

The system component node 40 whose ,installation is complete multicasts a packet including an identifier indicating the normal operation as data to the management node 50 and the relevant system component nodes 40 at regular time intervals as described above. Alternatively, the management node 50 receives a packet including an identifier indicating the normal operation from a specific system component node 40 by polling. If the definition information generation section 52 of the management node 50 does not receive the packet including the identifier for a predetermined time period, it is determined that system component nodes (for example, the actuators AC(1) to AC(4)) are disconnected from the network 100 and are deleted.

The global addresses of the actuators AC(1) to AC(4) corresponding to no packet reception are erased from the network definition DB 51b and the definition information of the actuators AC(1) to AC(4) is deleted from the tag definition DB 51c. Further, the definition information relevant to the actuators AC (1) to AC(4) stored in the operation and monitor screen definition DB 51e is also deleted. Accordingly, the actuators AC(1) to AC(4) are not displayed on the operation and monitor screen displayed by the screen generation section 54. From the installation positions of the actuators AC(1) to AC(4) included in the tag definition DB 51c, the definition information concerning the system component nodes 40 relevant to the actuators AC(1) to AC(4) is also changed.

(3) To replace the system component node 40.

Replacing of system component node 40 refers to replacing of a temperature sensor using a thermocouple thermometer with a radiation temperature sensor rather than replacing of thermocouple thermometer of the same kind in temperature sensors of one kind of the sensors SN(1) to SN(4), for example. First, the operation described above in (2) To delete system component node 40 is performed and then the operation in (1) To add system component node 40 is performed.

Thus, the communication section Tr of the system component node 40 generates the unique global address, establishes communications with the management node 50, and transmits the position information and the attribute information to the management node 50. The management node 50 changes the definition information in the DBs 51a to 51e from the position information and the attribute information and the screen generation section 54 displays the most recent operation and monitor screen on the display section 55. Accordingly, the operation can be started immediately after a system component node 40 is connected without the need for the system designer or developer to change the DBs 51a to 51e in an enormous number of steps each time a system component node 40 is changed. Therefore, the system configuration can be changed in a short time and the efficiency of system construction, administration, and maintenance can be improved drastically.

If addition, deletion, or replacement of system component node 40 results in a mismatch between the actual installation situation and the descriptions of the DBs 51a to 51e, the definition information generation section 52 detects and corrects the descriptions of the DBs 51a to 51e by itself, so that system mismatch can be suppressed.

Since the attribute information determination section 52b determines the attribute information included in the received packet for validity, if a third party connects an unauthorized system component node 40, the data from the unauthorized system component node 40 can be removed. The system reliability improves and an installation mistake can also be prevented.

Each of the communication sections Tr of the system component nodes 40 and the management node 50 conduct packet communications and thus can multiplex and transmit. Accordingly, if the number of lines of the network 100 is small, efficient communications can be conducted. Communications can also be conducted between the nodes 40 and 50 different in communication speed and communication means.

The authentication section Tr2 of the communication section Tr adds the authentication data to the header of each packet. Since the received packet is determined for validity based on the authentication data, the validity of the packet can be easily determined at the packet level and the system reliability improves.

Since the cryptograph processing section Tr3 of the communication section Tr encrypts a packet for transmission, leak, tampering, etc., of the data in the packet can be prevented and security improves.

Since the communication section Tr generates the unique global address, the address does not become duplicate in the management node 50 and the system component nodes 40. Therefore, it is unnecessary for the designer or the developer to check the addresses stored in the network definition DB 51b and assigns the addresses.

The communication section Tr of each system component node 40 multicasts the packet including the generated global address as the source address to all of the management node 50 and the system component nodes 40 connected to the system, and the communication section Tr of the management node 50 receives the multicasted packet and sends a response to the received packet to the system component node 40, so that the system component node 40 can automatically recognize the management node 50.

The communication section Tr uses the Internet protocol specification IPv6 as the communication protocol for connecting to the network 100 and thus can encrypt a packet, add authentication data to the header of the packet, and generate the global address according to the specifications.

Since the position detection section 41 detects the position where the home node is installed, if the operator misunderstands the installation position, the correct installation position is displayed on the display screen of the display section 55 and thus an installation mistake can be prevented.

[Second Embodiment]

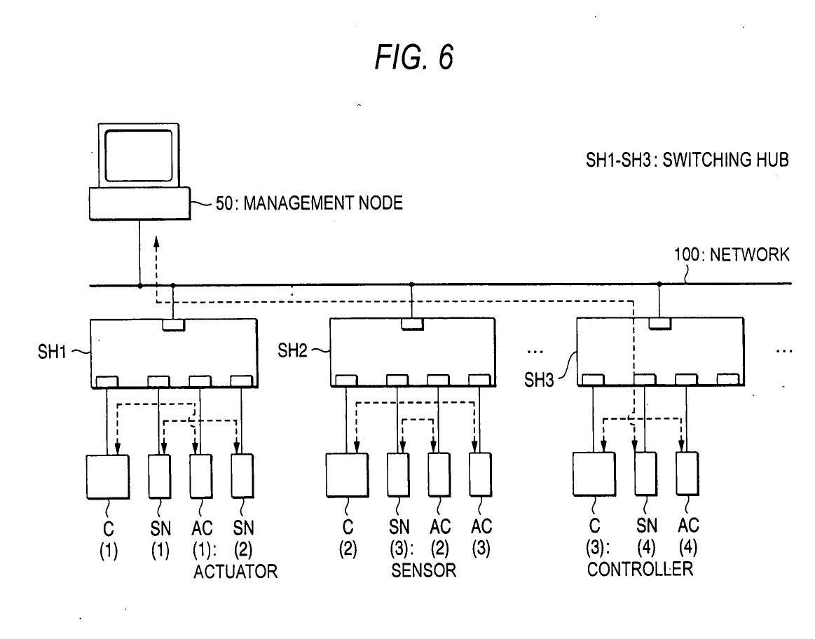

FIG. 6 is a diagram of a configuration to show a second embodiment of the invention. Parts identical with those in FIGS. 2 to 4 are denoted by the same reference numerals in FIG. 6 and will not be discussed again and are not shown either in the figure. A network 100 is provided with switching hubs SH1 to SH3 each having a plurality of ports. The switching hubs SH1 to SH3 are provided between the network 100 and system component nodes 40. Sensors SN(1) to SN(4) and actuators AC(1) to AC(4) for transmitting and receiving a packet to and from controllers C(1) to C(3) are connected to ports of the same switching hubs SH1 to SH3. Each of the switching hubs SH1 to SH3 has an address table for retaining the addresses of the system component nodes 40 connected to the ports. Further, each port of the switching hubs SH1 to SH3 has bridge means of a bridge function.

The operation of such an apparatus is as follows:

The operation of the apparatus shown in FIG. 6 is almost similar to that of the apparatus shown in FIG. 2 and differs in that the switching hubs SH1 to SH3 read the destination address included in the header of a packet from a management node 50, reference the address table, and transmit the packet to the system component node 40 of the destination. If the destination of the packet from a system component node 40 is a system component node 40 connected to the same switching hub SH1 to SH3 as the system component node 40, the switching hub SH1 to SH3 does not transmit the packet to the network 100 and transmits the packet only to the system component node 40 of the destination. Of course, if the destination is the management node 50 or a system component node 40 connected to different switching hub SH1 to SH3, the packet is transmitted to the network 100.

Thus, the switching hubs SH1 to SH3 are provided between the network 100 and the system component nodes 40 and therefore only the packets other than those transmitted to the system component nodes 40 in the same switching hub SH1 to SH3 are transmitted to the network 100. Accordingly, the traffic of the network 100 can be lessened.

Since each port has the bridge means, one-to-one communications can be conducted between the ports and if communications are being conducted in one pair, communications can be conducted freely in other ports. Accordingly, collision can be lowered.

[Third Embodiment]

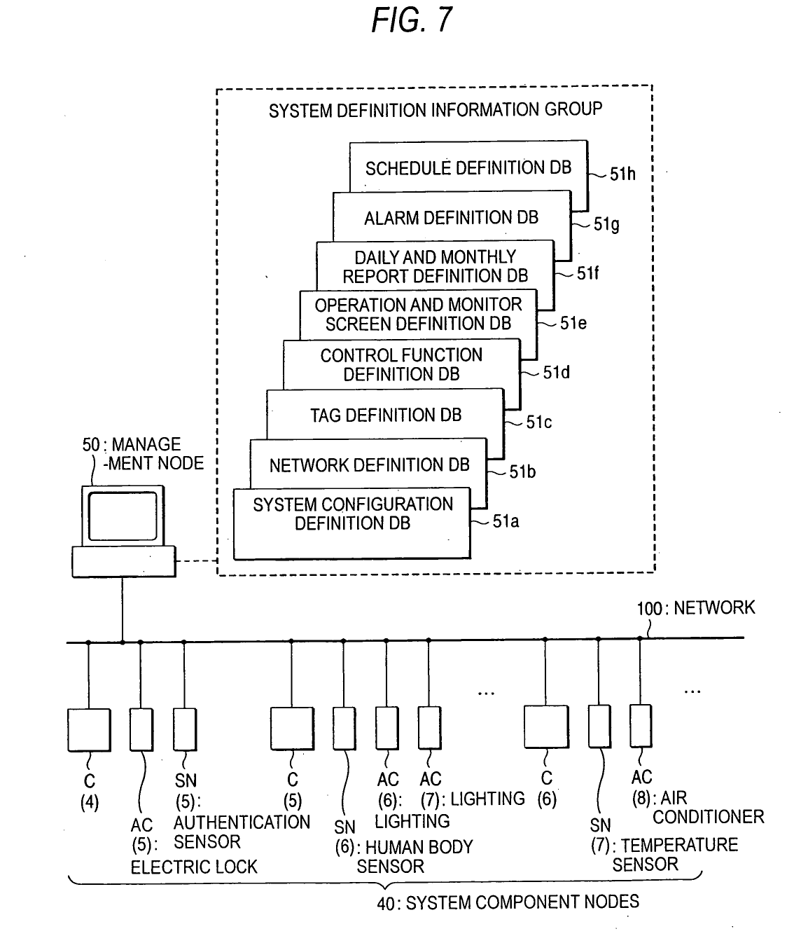

FIG. 7 is a diagram of a configuration to show a third embodiment of the invention and shows an example of applying the invention to BA. Parts identical with those in FIGS. 2 to 4 are denoted by the same reference numerals in FIG. 7 and will not be discussed again. In FIG. 7, controllers C(4) to C(6), sensors SN(5) to SN(7), and actuators AC (5) to AC (8) are provided in place of the controllers C(1) to C(3), the sensors SN(1) to SN(4), and the actuators AC(1) to AC (4), and are connected to a network. The sensors SN(5) to SN(7), the controllers C4 to C6, and the actuators AC(5) to AC(8) are system component nodes 40. For example, the sensors SN(5) to SN(7) are an authentication sensor, a human body sensor, and a temperature sensor respectively, and the actuators AC(5) and AC (8) are an electric lock of a door not shown and an air conditioner respectively and the actuators AC (6) and AC(7) are lighting.

The management node 50 is newly provided with DBs 51f to 51h of storage sections. The descriptions required for creating a daily and a monthly such as the power usage amounts consumed a day and a month by each system component node 40 and the number of persons authenticated with the authentication sensor SN(5) are defined in a daily and monthly report definition DB 51f as definition information. The types of alarms from the system component nodes 40 are defined in an alarm definition DB 51g as definition information. Schedules for operating the controllers C(4) to C(6) are defined in a schedule definition DB 51h as definition information.

The operation of such an apparatus is as follows:

The operation of the apparatus in initial installation and addition, deletion, and change of system component node 40 is almost similar to that of the apparatus shown in FIG. 2. As different operation, the definition information is also defined in the DBs 51f to 51h at the system design time. That is, in the BA, unlike the IA, the definition information for allowing the user entering the building to have a pleasant time and controlling the building at the minimum cost is defined in the DBs 51f to 51h. When the data has been downloaded into all system component nodes 40 from the management node 50, it is made possible to operate and monitor the control system through the screen from the management node 50, and building control can be managed.

For example, if the authentication result of the authentication sensor SN(5) is correct, the controller C(4) opens the electric lock of the door not shown. If the human body sensor SN(6) senses a human being, the controller C(5) turns on the lighting AC (6) and AC(7). Further, the controller C(6) operates the air conditioner AC(8) depending on the temperature from the temperature sensor SN(7). The input/output signals to/from the controllers C(4) to C(6) are transmitted to the management node 50 through the network 100. The data relevant to the items defined in the daily and monthly report definition DB 51g and the alarm definition 51g is also transmitted to the management node 50 through the network 100. The controllers C(4) to C(6) open/close the electric lock AC(5) and turn on/off the lighting AC(6) and AC(7) and the air conditioner AC(8) according to the schedules in the schedule definition DB. A screen generation section 54 may display an operation and monitor screen, the daily and monthly results, occurring alarms, the current schedule progress situation, etc., on a display section 55 by transmitting and receiving an operation and monitor screen definition DB 51f and the input/output signals to/from the controllers C(4) to C(6).

Thus, the control system of the invention is applied to the BA, whereby change of the system component node 40 in each room on each floor can be easily detected and the system configuration can be changed in a short time. Generally, for the IA, often the system component nodes 40 are installed under the instruction of the system designer or developer. In contrast, for the BA, the system component nodes 40 are connected to the network 100 as desired by the user using each floor, each room; this is a problem. The operator managing the management node 50 is difficult to enter each floor, each room without permission; this is also a problem.

However, the system component node 40 generates the unique global address, establishes communications with the management node 50, and transmits the position information and the attribute information to the management node 50. The management node 50 changes the definition information in the DBs 51a to 51h from the position information and the attribute information and the screen generation section 54 displays the most recent operation and monitor screen on the display section 55. Accordingly, it is unnecessary for the BA manager to enter each room, each floor and change the DBs 51a to 51h in an enormous number of steps each time a system component node 40 is changed. The user of each floor, each room can also connect any desired system component node 40 without making contact with the manager. The operation can be started immediately after the system component node 40 is connected. Therefore, the system configuration can be changed in a short time and the efficiency of system construction, administration, and maintenance can be improved drastically.

The invention is not limited to the embodiments and may be as follows:

In the apparatus shown in FIGS. 2, 6, and 7, the management node 50 and the system component nodes 40 conduct communications through the network 100 in one plant or one building, but communications between the management node 50 and each system component node 40 and communications between the system component nodes 40 may be conducted through the Internet, one kind of the network 100. That is, the management node 50 and the system component nodes 40 may be distributed in a wide area.

If the management node 50 and the system component nodes 40 are thus distributed in a wide area, the communication section Tr can generate the global address and conduct secure communications in accordance with the IPv6 specifications. That is, the address generation section Tr1 of the communication section Tr generates the unique global address, so that connecting to the Internet can be accomplished. The authentication section Tr2 adds the authentication data to the header of each packet, transmits the packets, and determines the received packet for validity based on the authentication data, so that the validity of the packet can be easily determined at the packet level and the system reliability improves. Further, since the cryptograph processing section Tr3 encrypts a packet for transmission, leak, tampering, etc., of the data in the packet can be prevented.

For example, to conduct communications through the Internet, for example, sufficient global addresses would be unable to be assigned with IPv4 (Internet Protocol version 4); this is a problem. Unauthorized access from the Internet also needs to be restricted. Thus, private addresses are assigned to the system component nodes 40 for each plant or for each building. A gateway and a network address translation unit (NAT: Network Address Translation) are provided between the Internet and the system component nodes 40 for enhancing security. Thus, it becomes difficult to externally operate and monitor the system component nodes 40. However, the communication section Tr generates the global address and conducts secure communications in accordance with the IPv6 specifications, so that the gateway and the NAT are not required. Accordingly, the system configuration can be simplified and the cost can be suppressed.

Since communications are conducted using the Internet, the management node 50 and the system component nodes 50 distributed in a wide area need not be connected by a leased line or a public network charged in response to the communications traffic for conducting communications and the laying cost and the communication charge can be suppressed.

In the apparatus shown in FIGS. 2, 6, and 7, the configuration of the IA is shown as an example of a large-scale control system and the configuration of the BA is shown as an example of a medium-scale control system, but the invention may be applied to any control system and may be applied to a small-scale control system (for example, LA).

In the apparatus shown in FIGS. 2, 6, and 7, the DBs 51a to 51h are provided for defining the definition information, but necessary definition information may be defined in response to the target control system.

In the apparatus shown in FIGS. 2, 6, and 7, the Internet protocol specification IPv6 is used as the communication protocol for connecting to the network 100, but any communication protocol may be used.

In the apparatus shown in FIGS. 2, 6, and 7, the authentication section Tr2 and the cryptograph processing section Tr3 are used, but both or either of the authentication section Tr2 and the cryptograph processing section Tr3 may be uninstalled if the reliability and security of the system component nodes 40 connected to the network 100 are secured.

In the apparatus shown in FIGS. 2, 6, and 7, the attribute information determination section 52b for determining the system component nodes 40 for validity is provided, but if an installation mistake and the reliability of the system component nodes 40 are secured, the attribute information determination section 52b may be uninstalled.

In the apparatus shown in FIGS. 2, 6, and 7, the position detection section 41 performs position determination by GPS using radio waves from an artificial satellite and detects the position, but a plurality of radio wave base stations for emitting radio waves may be installed in a plant or a building and the system component node 40 may receive the radio waves emitted from the radio wave base stations and may detect the position of the home node based on the received radio wave strength. Particularly, the mode is effective in a place that the radio waves from the satellite do not reach or are hard to reach (for example, underground or valley between tall buildings). The position may be detected using ultrasonic waves rather than radio waves.

In the apparatus shown in FIGS. 2, 6, and 7, the position detection section 41 self-detects the installation position. However, before installation, position information may be previously stored in the position detection section 41 for skipping self-detection.

Further, in the apparatus shown in FIGS. 2, 6, and 7, the execution section 45 of each of the controllers C(1) to C(6) executes the operation in accordance with the control functions defined by the definition information generation section 52, but self-learning section (for example, a neural network) for learning more appropriate control functions may be provided by transmitting and receiving the input/output signals to/from the sensors SN(1) to SN(7) and the actuators AC(1) to AC(8). The self-learning section may transmit the learnt control functions to the management node 50 through the communication section Tr. Further, the definition information generation section 52 of the management node 50 may generate definition information of the control functions according to the control functions from the controllers C(1) to C(6) and may store the definition information in the control function definition DB 51d.

Thus, the self-learning section of the controllers C(1) to C(6) learn more appropriate control functions by transmitting and receiving the input/output signals to/from the sensors SN(1) to SN(7) and the actuators AC(1) to AC(8) and reflect the control functions on the control function DB 51d of the management node 50, so that the need for the operator to find the optimum control function from the operation and monitor screen of the display section 55 and store the optimum control function in the control function DB 51 is eliminated. Accordingly, the number of steps taken after the system configuration is changed can be reduced.

1. A control system established through a network, the control system comprising:
a plurality of system component nodes each having a communication section for generating a unique global address by the system component node itself upon connection to the network, and for transmitting the generated global address, attribute information of the system component node and installation position information of the system component node, to the network; and
a management node for monitoring and operating the system component nodes through the network and managing control of the whole control system, wherein
the management node includes:
a communication section for performing communication through the network;
a storage section for storing definition information of the system component nodes;
a display section for displaying an operation and monitor screen;
a definition information generation section for generating definition information based on the global address, the attribute information and the position information which are acquired through the network, and for storing the definition information in the storage section;
a screen generation section for making the display section display the operation and monitor screen of the system component nodes from the definition information in the storage section; and
a control function providing section for reading information defining an operation of the system component node from the storage section, and for outputting the read information to the communication section.

2. The control system as claimed in claim 1, wherein the system component nodes are at least one of a sensor, an actuator and a controller.

3. The control system as claimed in claim 1, wherein the definition information includes the global address, an installation position, a tag, a control function and a configuration of the operation and monitor screen of the system component node.

4. The control system as claimed in claim 1, wherein the definition information generation section has an attribute information determination section for determining validity of the attribute information.

5. The control system as claimed in claim 1 or 4, wherein the attribute information includes at least one of a type, a manufacturer, a model and a serial number of the system component node.

6. The control system as claimed in claim 1, wherein the communication sections of the system component node and the management node have an address generation section for generating a unique global address.

7. The control system as claimed in claim 1, wherein the communication sections of the system component node and the management node perform packet communication.

8. The control system as claimed in claim 7, wherein the communication section has an authentication section for adding authentication data to a header of a packet, and determining validity of the received packet according to the authentication data added to the packet.

9. The control system as claimed in claim 7, wherein the communication section has a cryptograph processing section for encrypting a packet.

10. The control system as claimed in claim 7, wherein the communication section of the system component node multicasts a packet including the generated global address as a source address to all of the management node and the system component nodes connected to the system, and
the communication section of the management node receives the multicasted packet and sends a response to the received packet to the system component node.

11. The control system as claimed in any one of claims 6 to 10, wherein Internet protocol specification IPv6 is used as a communication protocol for connecting to the network.

12. The control system as claimed in claim 1, wherein the system component node has a position detection section for detecting the installation position.

13. The control system as claimed in claim 12, wherein the position detection section detects the position using radio waves or ultrasonic waves.

14. The control system as claimed in claim 1, wherein the network has a switching hub, and
the system component node is connected to the switching hub.

15. The control system as claimed in claim 2, wherein the controller has a self-learning section for learning more appropriate control function by performing transmission and reception to and from the sensor and the actuator, and transmits the learned control function to the management node, and
the definition information generation section of the management node generates the definition information according to the control function from the controller.

16. The control system as claimed in claim 1, wherein the management node performs communication with the system component node through the network.
